(19) United States
(12) Patent Application Publication
(10) Pub. No.: US 2010/0128155 A1
(43) Pub. Date: May 27, 2010

(54) Image sensors and methods of manufacturing the same

(75) Inventors: Jung Chak Ahn, Yongin-si (KR); Tae Sub Jung, Anyang-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/591,392

(22) Filed: Nov. 18, 2009

(30) Foreign Application Priority Data
Nov. 21, 2008 (KR) 10-2008-0116284

(51) Int. Cl. H04N 5/335; G01J 1/42; G01J 1/04

(52) U.S. Cl. 348/308; 250/227.11; 29/592.1; 250/226; 348/E05.091

(57) ABSTRACT

Image sensors and methods of manufacturing image sensors, the image sensors including a plurality of photoelectric conversion units formed within active regions defined in a semiconductor substrate; and a plurality of light guides having structures for guiding light incident from an external source onto the semiconductor substrate and the plurality of photoelectric conversion units, the light guides having different widths.

### PRIORITY STATEMENT

This application claims the benefit of Korean Patent Application No. 10-2008-0116284 filed on Nov. 21, 2008, the subject matter of which is hereby incorporated in its entirety by reference.

### BACKGROUND

Example embodiments relate to image sensors, and more particularly, to complementary metal oxide semiconductor (CMOS) image sensors and methods of manufacturing the same.

Image sensors are devices that convert an optical image into an electrical signal. With recent developments in the computer and communications industries, a demand for CMOS image sensors having improved performance is increasing for various applications such as digital cameras, camcorders, personal communication systems (PCSs), game players, security cameras, medical micro cameras, and robots.

CMOS image sensors may include a photo diode for sensing externally-incident light, and a circuit for converting the sensed light into an electrical signal and digitizing the electrical signal. As the amount of light received by the photo diode increases, the photo sensitivity of the CMOS image sensor increases. A CMOS image sensor may include a plurality of photodiodes formed on a semiconductor substrate, a plurality of color filters formed to correspond to the photodiodes in order to pass light in specific wavelength bands (e.g., bandwidths), and a plurality of lenses formed to correspond to the color filters.

Light externally incident onto an CMOS image sensor may be focused by the lenses, filtered by the color filters, and fall onto the photo diodes corresponding to the color filters. The CMOS image sensor includes a light guide disposed between the color filters and the photodiodes. The light guide guides light incident from an external source via the lenses and the light is passed through the color filters to fall onto the photo diodes corresponding to the color filters.

In conventional CMOS image sensors, the light guide is formed with the same width (for example, a horizontal length) regardless of the types of color filters (e.g., red, green, and blue color filters) or the wavelength and/or range of wavelengths of externally incident light. However, light respectively passed through all channels (e.g., red, green, and blue color filters) of a conventional CMOS image sensor have different wavelengths and/or range of wavelengths, and thus a conventional light guide may not contribute to obtaining highly-efficient and/or improved CMOS image sensors.

### SUMMARY

Example embodiments provide highly-efficient and/or improved image sensors. Example embodiments also provide methods of manufacturing the highly-efficient and/or improved image sensors.

According to example embodiments, there is provided an image sensor including a plurality of photoelectric conversion units and a plurality of light guides, at least two of the plurality of light guides having different widths.

According to example embodiments, there is also provided a method of manufacturing an image sensor, the method including forming a plurality of photoelectric conversion units and forming a plurality of light guides such that at least two of the plurality of light guides have different widths.

### BRIEF DESCRIPTION OF THE DRAWINGS

Example embodiments will be more clearly understood from the following brief description taken in conjunction with the accompanying drawings. FIGS. 1-10 represent non-limiting example embodiments as described herein.

FIG. 1 is a circuit diagram of a unit pixel of an image sensor according to an example embodiment;

FIG. 2 is a schematic layout of an image sensor according to an example embodiment;

FIG. 3 is a cross-sectional diagram illustrating cross-sections taken along lines III-III′ and III′-III″ of FIG. 2;

FIGS. 4A and 4B are graphs of width as a function of optical efficiency, showing the widths of light guides included in the image sensor illustrated in FIG. 3 as a function of optical efficiency according to a refraction ratio of a material used to form the light guides; and

FIG. 5 is a schematic block diagram of an image sensing system including the image sensor illustrated in FIGS. 2 and 3 according to an example embodiment.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF EXAMPLE EMBODIMENTS

Example embodiments will now be described more fully with reference to the accompanying drawings, in which example embodiments are shown. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Image sensors according to example embodiments may include a charge coupled device (CCD) image sensor and/or a complementary metal oxide semiconductor (CMOS) image sensor. A CCD generates small noise and provides a high-quality image as compared with the CMOS image sensor. However, a CCD requires a higher voltage and is manufactured at higher costs. A CMOS image sensor is simply driven and can be implemented according to various scanning methods. Because signal processing circuits can be integrated into a single chip, a CMOS image sensor can be made compact. A CMOS image sensor is compatible with CMOS processing techniques, reducing and/or improving the manufacturing costs of CMOS image sensors. A CMOS image sensor consumes very little power and accordingly is easily applied to products that have limits in battery capacity.

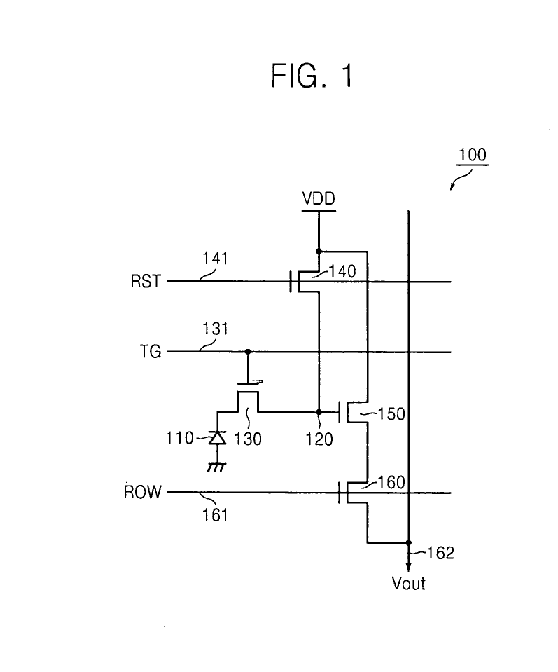

FIG. 1 is a circuit diagram of a unit pixel 100 of an image sensor according to an example embodiment. Referring to FIG. 1, the unit pixel 100 may include a photoelectric conversion unit 110, a charge detection unit 120, a charge transmission unit 130, a reset unit 140, an amplification unit 150, and a selection unit 160. In the present embodiment, a case where the unit pixel 100 includes four transistors is illustrated. However, the unit pixel 100 may include N transistors, where N is a natural number (e.g., 3 or 5).

The photoelectric conversion unit 110 may absorb incident light and accumulate charges corresponding to the intensity of radiation. The photoelectric conversion unit 110 may be, for example, a photo diode, a photo transistor, a photo gate, a pinned photo diode (PPD), or a combination thereof. A floating diffusion (FD) region may be used as the charge detection unit 120. The charge detection unit 120 may receive the accumulated charges from the photoelectric conversion unit 110. Because the charge detection unit 120 may have parasitic capacitance, charges may be accumulatively stored in the charge detection unit 120. The charge detection unit 120 may be electrically connected to a gate of the amplification unit 150 and accordingly may control the amplification unit 150.

The charge transmission unit 130 may transmit the charges from the photoelectric conversion unit 110 to the charge detection unit 120. The charge transmission unit 130 may generally be made up of one transistor and may be controlled by a charge transmission signal TG. The charge transmission signal TG may be transmitted by the charge transmission line 131. The reset unit 140 may periodically reset the charge detection unit 120 and may be controlled by a reset signal RST. The reset signal RST may be transmitted by a reset line 141. A source of the reset unit 140 may be connected to the charge detection unit 120, and a drain thereof may be connected to a power source VDD. The reset unit 140 may be driven in response to a reset signal RST.

The amplification unit 150 may be combined with a static current source (not shown) located outside the unit pixel 100 so as to serve as a source follower buffer amplifier. A voltage that varies in response to a voltage of the charge detection unit 120 may be output to a vertical signal line 162. A source of the amplification unit 150 may be connected to a drain of the selection unit 160, and a drain of the amplification unit 150 may be connected to the power source VDD. The selection unit 160 may select the unit pixel 100 which is to be read in units of rows and may be controlled by a selection signal ROW. The selection signal ROW may be transmitted by a row line 161. The selection unit 160 may be driven in response to the selection signal ROW, and a source of the selection unit 160 may be connected to the vertical signal line 162. The vertical signal line 162 may transmit an output signal Vout.

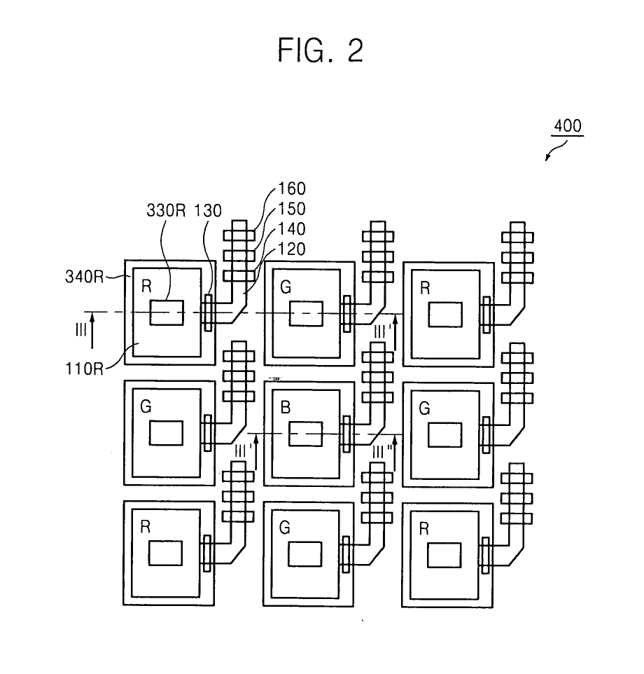

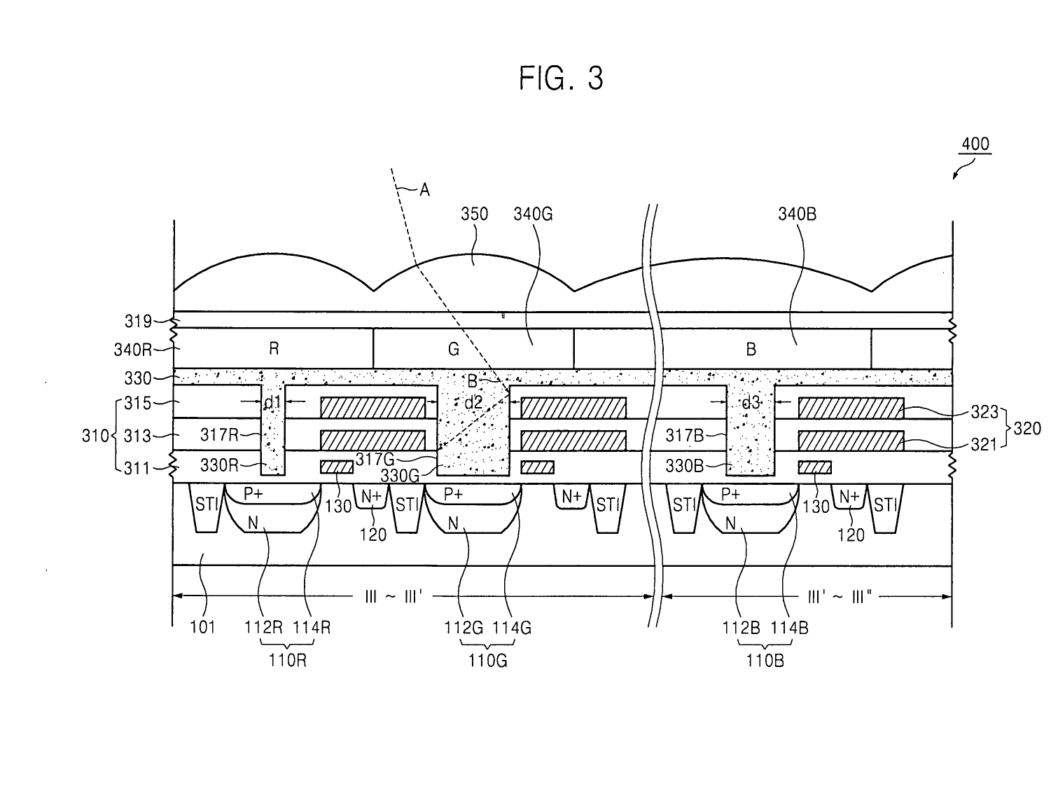

An image sensor 400 according to an example embodiment will now be described with reference to FIGS. 2 and 3. FIG. 2 is a schematic layout of the image sensor 400 according to an example embodiment. FIG. 3 is a cross-sectional diagram illustrating cross-sections taken along lines III-III′ and III′-III″ of FIG. 2.

The image sensor 400 according to the present example embodiment may include a plurality of the unit pixels 100 laid out in a matrix form and may convert an optical image into an electrical signal. Light incident from an external source passes through color filters and reaches photoelectric conversion units (e.g., photo diodes). Charges may be accumulated, the charges corresponding to incident light of a wavelength and/or a range of wavelengths in a region. In particular, although the color filters in the present embodiment may be arranged in a Bayer pattern as illustrated in FIG. 2, example embodiments are not limited to this arrangement.

Referring to FIGS. 2 and 3, the image sensor 400 may include a plurality of channels, for example, a first channel, a second channel, and a third channel, on a semiconductor substrate 101. The first through third pixels may include first through third photoelectric conversion units 110R, 110G, and 110B, first through third light guides 330R, 330G, and 330B, and first through third color filters 340R, 340G, and 340B, respectively. For example, the first channel may include the first photoelectric conversion unit 11 OR within the semiconductor substrate 101, the first light guide 330R over the first photoelectric conversion unit 110R so as to correspond to the first photoelectric conversion unit 110R, and the first color filter 340R (e.g., a red color filter) on the first light guide 330R so as to correspond to the first photoelectric conversion unit 110R and/or the first light guide 330R.

The second channel may include the second photoelectric conversion unit 110G within the semiconductor substrate 101, the second light guide 330G over the second photoelectric conversion unit 110G so as to correspond to the second photoelectric conversion unit 110G, and the second color filter 340G (e.g., a green color filter) on the second light guide 330G so as to correspond to the second photoelectric conversion unit 110G and/or the second light guide 330G. The third channel may include the third photoelectric conversion unit 110B within the semiconductor substrate 101, the third light guide 330B over the third photoelectric conversion unit 110B so as to correspond to the third photoelectric conversion unit 110B, and the third color filter 340B (e.g., a blue color filter) on the third light guide 330B so as to correspond to the third photoelectric conversion unit 110B and/or the third light guide 330B.

The first through third photoelectric conversion units 110R, 110G, and 110B may be separated from one another by isolation regions STI within the semiconductor substrate 101, and may be adjacent to one another. The isolation regions STI may be in the semiconductor substrate 101 so as to define active regions. The first through third channels may be respectively in the active regions defined by the isolation regions STI. The isolation regions STI may be Field OXide (FOX) or shallow trench isolation (STI) regions which may be formed using a LOCal Oxidation of Silicon (LOCOS) method.

The first through third photoelectric conversion units 110R, 110G, and 110B may be in the active regions defined in the semiconductor substrate 101 by the isolation regions STI, and may accumulate charges generated due to absorption of light energy incident from an external source. The first through third photoelectric conversion units 110R, 110G, and 110B may include N-type photo diodes 112R, 112G, and 112B, respectively, and P+-type pinning layers 114R, 114G, and 114B, respectively.

On each of the first through third photoelectric conversion units 110R, 110G, and 110B, a charge transmission unit 130 may be located, and transistors corresponding to the charge detection unit 120, the reset unit 140, the amplification unit 150, and the selection unit 160 may be connected. At least one dielectric layer structure 310 (e.g., a dielectric layer structure 310 including at least one layer) may be on the first through third photoelectric conversion units 110R, 110G, and 110B or on the charge transmission units 130 such as to cover the entire surface of the semiconductor substrate 101 and to fill empty spaces.

For example, an interlayer dielectric layer 311 may be on the first through third photoelectric conversion units 110R, 110G, and 110B or on the charge transmission units 130 such as to cover the entire surface of the semiconductor substrate 101. The interlayer dielectric layer 311 may be, for example, an oxide layer or a combination of an oxide layer and a nitride layer. Wiring patterns 320 may be on the interlayer dielectric layer 311. Each of the wiring patterns 320 may be a single layer or made up of multiple layers (e.g., 2 or 3 layers). In the present example embodiment, each of the wiring patterns 320 may include a first wiring pattern 321 and a second wiring pattern 323.

The first wiring patterns 321 may be on the interlayer dielectric layer 311. The first wiring patterns 321 may be, for example, aluminum (Al), tungsten (W), or copper (Cu) and may be in peripheral circuit regions. The peripheral circuit regions may denote regions not occupied by channels, for example, regions not occupied by the first through third photoelectric conversion units 110R, 110G, and 110B, on the semiconductor substrate 101. Regions occupied by the first through third photoelectric conversion units 110R, 110G, and 110B on the semiconductor substrate 101 may be defined as light-receiving regions.

A first metal-interlayer dielectric layer 313 may be on the first wiring patterns 321 and/or on the interlayer dielectric layer 311. The first metal-interlayer dielectric layer 313 may be, for example, an oxide layer and/or a combination of the oxide layer and a nitride layer. The second wiring patterns 323 may be on the first metal-interlayer dielectric layer 313. The second wiring patterns 323 may be arranged over the first wiring patterns 321 so as to face each other, and may be connected to the first wiring patterns 321 through vias (not shown). The second wiring patterns 323 may be of the same material as the material used to form the first wiring patterns 321 (e.g., Al, W, or Cu). A second metal-interlayer dielectric layer 315 may be on the second wiring patterns 323 or on the first metal-interlayer dielectric layer 313. The second metal-interlayer dielectric layer 315 may be of the same material as the material used to form the first metal-interlayer dielectric layer 313 (e.g., an oxide layer and/or a combination of the oxide layer and a nitride layer).

The first and second metal-interlayer dielectric layers 313 and 315 may be, for example, flowable oxide (FOX), high density plasma (HDP), Tonen SilaZene (TOSZ), spin on glass (SOG), undoped silica glass (USG), or the like. A region of the dielectric layer structure 310, for example, regions of the interlayer dielectric layer 311 and the first and second metal-interlayer dielectric layers 313 and 315, may include a plurality of opening regions 317R, 317G, and 317B corresponding to the first through third photoelectric conversion units 110R, 110G, and 110B, respectively.

Hereinafter, the opening regions 317R, 317G, and 317B will be referred to as first, second, and third opening regions 317R, 317G, and 317B. Each of the first through third opening regions 317R, 317G, and 317B may be formed by etching the dielectric layer structure 310, including the interlayer dielectric layer 311 and the first and second metal-interlayer dielectric layers 313 and 315. The dielectric layer structure 310 may be etched by, for example, wet etching.

The first opening region 317R may extend from the second metal-interlayer dielectric layer 315 to a region over the first photoelectric conversion unit 110R, for example, to a portion of the interlayer dielectric layer 311 on the first photoelectric conversion unit 110R. The second opening region 317G may extend from the second metal-interlayer dielectric layer 315 to a region over the second photoelectric conversion unit 110G, for example, to a portion of the interlayer dielectric layer 311 on the second photoelectric conversion unit 110G. The third opening region 317B may extend from the second metal-interlayer dielectric layer 315 to a region over the third photoelectric conversion unit 110B, for example, to a portion of the interlayer dielectric layer 311 on the third photoelectric conversion unit 110B.

The first through third opening regions 317R, 317G, and 317B may have regions of the interlayer dielectric layer 311 on the first through third photoelectric conversion units 110R, 110G, and 110B that are exposed (e.g., by etching). The first through third opening regions 317R, 317G, and 317B may have different widths, for example, different horizontal lengths d1, d2, and d3. The first through third light guides 330R, 330G, and 330B may have different widths according to the widths d1, d2, and d3 of the first through third opening regions 317R, 317G, and 317B. For example, the width d1 of the first opening region 317R may be the same as a width d1 of the first light guide 330R, the width d2 of the second opening region 317G may be the same as a width d2 of the second light guide 330G, and the width d3 of the third opening region 317B may be the same as a width d3 of the third light guide 330B.

The widths d1, d2, and d3 of the first through third opening regions 317R, 317G, and 317B may vary according to, for example, a wavelength and/or a range of wavelengths of a first incident light beam A, a wavelength and/or a range of wavelengths of a second incident light beam B, turns, and/or a refraction ratio “n” of a material included in the first through third light guides 330R, 330G, and 330B. The first incident light beam A may be a light beam incident from an external source (e.g., a dedicated light source and/or ambient light). A range of wavelengths of a second incident light beam B may be determined by the passing of the first incident light beam A through one or more of the first through third color filters 340R, 340G, and 340B. A material used to form the first through third light guides 330R, 330G, and 330B may be a light guide material.

A range of wavelengths of the first incident light beam A may include all, or less than all, of the wavelengths that may be passed by one of the first through third color filters 340R, 340G, and 340B. For example, the first incident light beam may include half of the wavelengths that may be passed by one of the first through third color filters 340R, 340G, and 340B. The first through third color filters 340R, 340G, and 340B, may pass the second incident light beam B having a wavelength or a range of wavelengths according to the first incident light beam. For example, the second incident light beam B may include half the wavelengths that may be passed by one of the first through third color filters 340R, 340G, and 340B. The widths d1, d2, and d3, may vary according to a wavelength and/or a range of wavelengths of a first incident light beam A, and/or a wavelength and/or a range of wavelengths of a second incident light beam B. The widths d1, d2, and d3 may vary based on any number of parameters affecting optical transmission and may be tailored for optimal and/or improved optical efficiency. The widths d1, d2, and d3 may be calculated or may be empirically determined.

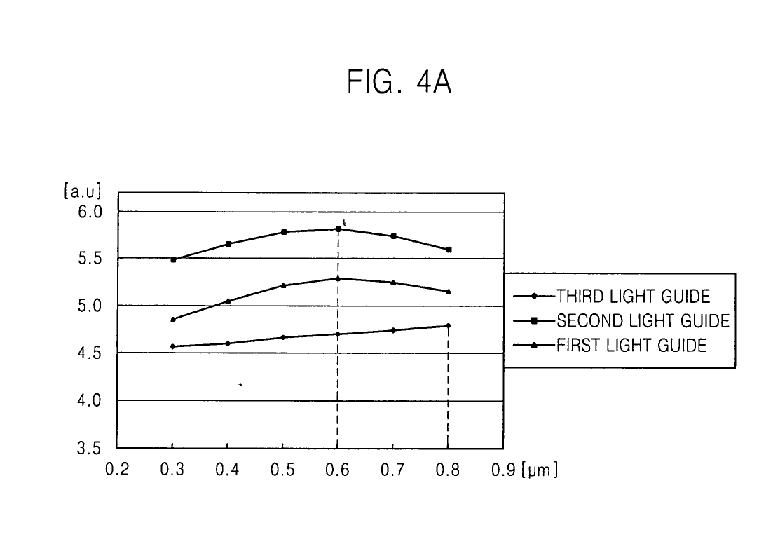

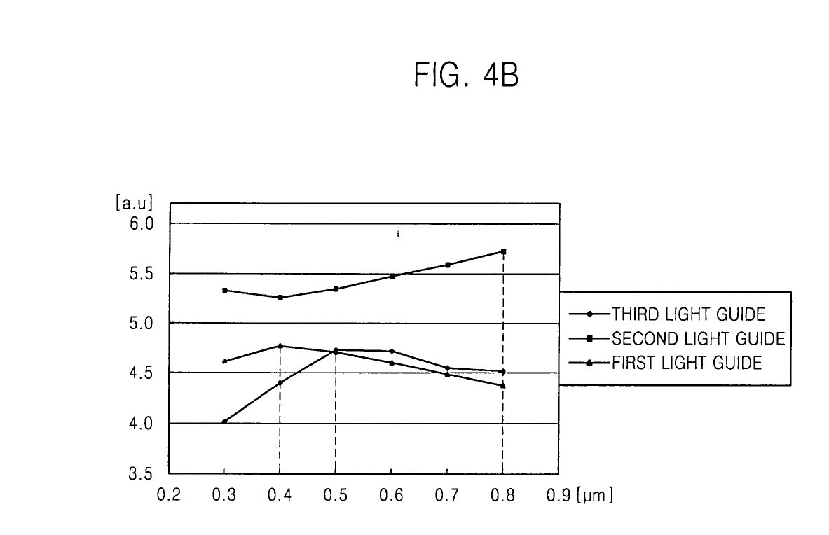

FIGS. 4A and 4B are graphs of width as a function of optical efficiency, showing the widths d1, d2, and d3 of the first through third light guides 330R, 330G, and 330B illustrated in FIG. 3 as a function of optical efficiency according to the refraction ratio of a material used to form the first through third light guides 330R, 330G, and 330B.

Referring to FIGS. 3 and 4A, when the material used for the first through third light guides 330R, 330G, and 330B has a first refraction ratio n1 of about 1.57, the width d1 of the first opening region 317R (and/or the width of the first light guide 330R) may be about 0.6 μm in order to obtain optimal and/or improved light efficiency. The width d2 of the second opening region 317G (and/or the width of the second light guide 330G) may be about 0.6 μm in order to obtain optimal and/or improved light efficiency. The width d3 of the third opening region 317B (and/or the width of the third light guide 330B) may be about 0.8 μm in order to obtain optimal and/or improved light efficiency.

Referring to FIGS. 3 and 4B, when the material used for the first through third light guides 330R, 330G, and 330B has a second refraction ratio n2 of about 1.68, the width d1 of the first opening region 317R (and/or the width of the first light guide 330R) may be about 0.4 μm in order to obtain optimal and/or improved light efficiency. The width d2 of the second opening region 317G (and/or the width of the second light guide 330G) may be about 0.8 μm in order to obtain optimal and/or improved light efficiency. The width d3 of the third opening region 317B (and/or the width of the third light guide 330B) may be about 0.5 μm in order to obtain optimal and/or improved light efficiency.

As described above, the widths d1, d2, and d3 of the first through third opening regions 317R, 317G, and 317B of the dielectric layer structure 310 (and/or the widths of the first through third light guides 330R, 330G, and 330B) may be set differently according to the refraction ratio of the material used to form the first through third light guides 330R, 330G, and 330B, so that high and/or improved light efficiency may be obtained for each channel. Although the widths d1, d2, and d3 of the first through third opening regions 317R, 317G, and 317B of FIG. 3 are the same as those illustrated in FIG. 4B, example embodiments are not limited thereto. In FIGS. 4A and 4B, the X axis may denote the widths d1, d2, and d3 of the first through third opening regions 317R, 317G, and 317B (and/or the first through third light guides 330R, 330G, and 330B), and the Y axis may denote light efficiency.

Referring to FIG. 3, the first through third light guides 330R, 330G, and 330B may be over the first through third photoelectric conversion units 110R, 110G, and 110B so as to face the first through third photoelectric conversion units 110R, 110G, and 110B, respectively. For example, the first through third light guides 330R, 330G, and 330B may be obtained by forming a light guide layer 330 on the first through third opening regions 317R, 317G, and 317B and/or on the second metal-interlayer dielectric layer 315 by using a light guide material (e.g., an oxide-based material). The light guide material may have a higher refraction ratio than a material used to form the dielectric layer structure 310, namely, the material(s) of the interlayer dielectric layer 311 and the first and second metal-interlayer dielectric layers 313 and 315.

The first through third light guides 330R, 330G, and 330B may entirely reflect externally-incident light. The first incident light beam A or the second incident light beam B may be reflected at least once so that the externally-incident light falls on the first through third photoelectric conversion units 110R, 110G, or 110B adjacent to the externally-incident light. For example, the first light guide 330R may receive the second incident light beam B incident from an external source via the first color filter 340R, and may perform at least one entire reflection (e.g., total internal reflection) so that the second incident light beam B falls on the first photoelectric conversion unit 110R. The second light guide 330G may perform at least one entire reflection so that the second incident light beam B incident via the second color filter 340G is received by the second photoelectric conversion unit 110G. The third light guide 330B may perform at least one entire reflection so that the second incident light. beam B incident via the third color filter 340B is received by the third photoelectric conversion unit 110B.

Reflection of incident light may occur because a light guide material(s) used to form the first through third light guides 330R, 330G, and 330B may have a higher refraction ratio than the material used to form the dielectric layer structure 310 adjacent to the first through third light guides 330R, 330G, and 330B. The first through third light guides 330R, 330G, and 330B may be formed, for example, by filling the first through third opening regions 317R, 317G, and 317B, respectively, with a light guide material coated on the second metal-interlayer dielectric layer 315.

The first light guide 330R may be formed by, for example, filling the first opening region 317R with a light guide material. One surface of the first light guide 330R may be adjacent to the first photoelectric conversion unit 110R, and the other surface thereof may be adjacent to the first color filter 340R. The first light guide 330R may guide the second incident light beam B that is passed through the first color filter 340R to the first photoelectric conversion unit 110R.

The second light guide 330G may be formed by, for example, filling the second opening region 317G with a light guide material. One surface of the second light guide 330G may be adjacent to the second photoelectric conversion unit 110G, and the other surface thereof may be adjacent to the second color filter 340G. The second light guide 330G may guide the second incident light beam B that is passed through the second color filter 340G to the second photoelectric conversion unit 110G.

The third light guide 330B may be formed by, for example, filling the third opening region 317B with a light guide material. One surface of the third light guide 330B may be adjacent to the third photoelectric conversion unit 110B, and the other surface thereof may be adjacent to the third color filter 340B. The third light guide 330B may guide the second incident light beam B that is passed through the third color filter 340B to the third photoelectric conversion unit 110B.

As described above, the first through third light guides 330R, 330G, and 330B may have different widths d1, d2, and d3, respectively. For example, the widths d1, d2, and d3 of first through third light guides 330R, 330G, and 330B may be the same as the widths d1, d2, d3 of the first through third opening regions 317R, 317G, and 317B, respectively. The first through third color filters 340R, 340G, and 340B (e.g., red, green, and blue color filters) may be on the first through third light guides 330R, 330G, and 330B and/or on the light guide layer 330.

The red color filter 340R (e.g., the first color filter 340R) may be on the first light guide 330R. The red color filter 340R may be at a location that faces the first light guide 330R and/or the first photoelectric conversion unit 110R. The green color filter 340G (e.g., the second color filter 340G), may be on the second light guide 330G. The green color filter 340G may be at a location that faces the second light guide 330G and/or the second photoelectric conversion unit 110G. The blue color filter 340B (e.g., the third color filter 340B) may be on the third light guide 330B. The blue color filter 340B may be at a location that faces the third light guide 330B and/or the third photoelectric conversion unit 110B.

The first through third color filters 340R, 340G, and 340B may have larger widths than the first through third light guides 330R, 330G, and 330B, respectively. A passivation film 319 may be on the upper surfaces of the first through third color filters 340R, 340G, and 340B. The passivation film 319 may protect structures located under the passivation film 319, for example, the first through third color filters 340R, 340G, and 340B, the first through third photoelectric conversion units 110R, 110G, and 110B, and the first through third light guides 330R, 330G, and 330B. The passivation film 319 may be of a material that allows externally-incident light (e.g., the first incident light beam A), to easily pass.

Micro lenses 350 may be on the passivation film 319 so as to align with the red, green, and blue color filters 340R, 340G, and 340B (e.g., the first through third color filters 340R, 340G, and 340B). The micro lenses 350 may be, for example, TMR-based resin or MFR-based resin.

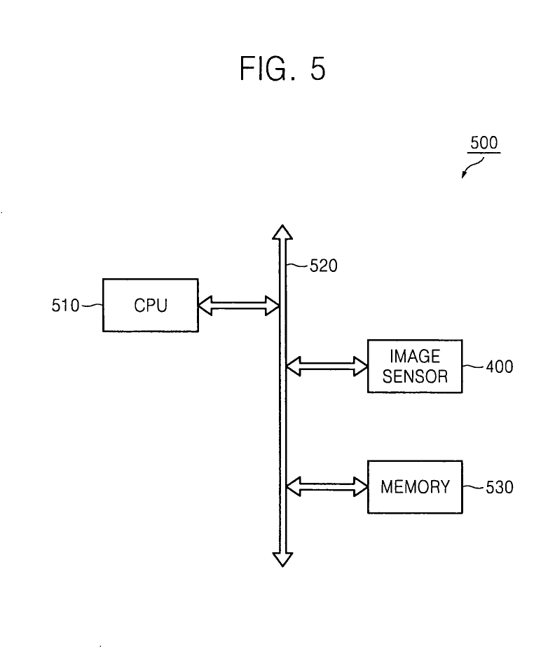

FIG. 5 is a schematic block diagram of an image sensing system 500 including the image sensor 400 described above with reference to FIGS. 1-4, according to example embodiments. The image sensing system 500 may be, for example, a computer system, a camera system, a scanner, a mechanized clock system, a navigation system, a video phone, a management system, an auto focusing system, an operation-monitoring system, an image stabilization system, or the like. Various other systems may be used as the image sensing system 500.

Referring to FIG. 5, the image sensing system 500, which may be a computer system, may include a bus 520, a central processing unit (CPU) 510, the image sensor 400, and a memory 530. Although not shown in FIG. 5, the image sensing system 500 may further include an interface that is connected to the bus 520 so as to communicate with the outside. The interface may be an input/output (I/O) interface or a wireless interface. The CPU 510 may generate a control signal for controlling an operation of the image sensor 400, and provide the control signal to the image sensor 400 via the bus 520. The image sensor 400 may include, for example, an APS array, a row driver, and an analog-to-digital converter (ADC). The image sensor 400 may sense light according to the control signal provided from the CPU 510 and convert the light into an electrical signal to thereby generate an image signal. The memory 530 may receive the image signal from the image sensor 400 via the bus 520 and store the image signal. The image sensor 400 may be integrated with the CPU 510, the memory 530, and the like. In some cases, the image sensor 400 may be integrated with a digital signal processor (DSP), or only the image sensor 400 may be integrated into a separate chip.

Provided are image sensors and a methods of manufacturing the image sensors, according to one or more example embodiments, including a plurality of light guides that may be formed to have different widths. Light efficiency of the image sensor with respect to externally incident light may improve.

While example embodiments have been particularly shown and described with, it will be understood by one of ordinary skill in the art that various changes in form and details may be made therein without departing from the spirit and scope of the claims.

What is claimed is:

1. An image sensor, comprising:
a plurality of photoelectric conversion units in a substrate; and
a plurality of light guides on the plurality of photoelectric conversion units, the plurality of light guides configured to guide light incident from a source external to the substrate onto the plurality of photoelectric conversion units, at least two of the plurality of light guides having different widths.

2. The image sensor of claim 1, wherein each of the plurality of light guides is a different width and includes a light guide material, and
the different widths are based on a refraction ratio of the light guide material.

3. The image sensor of claim 1, wherein the different widths are based on one or more properties of the incident light.

4. The image sensor of claim 3, wherein the one or more properties of the incident light include at least one of a range of wavelengths of the light incident from the external source and a range of wavelengths of the light incident onto the photoelectric conversion units.

5. The image sensor of claim 1, wherein each of the plurality of light guides corresponds to a different one of the plurality of photoelectric conversion units, and
the plurality of light guides are configured to entirely reflect incident light at least once, such that the light from the external source incident onto one of the plurality of light guides does not reach a non-corresponding one of the photoelectric conversion units.

6. The image sensor of claim 1, further comprising a dielectric layer structure on the plurality of photoelectric conversion units and including at least one layer, the dielectric structure including a plurality of opening regions filled by the plurality of light guides, each of the plurality of opening regions corresponding to and facing one of the plurality of photoelectric conversion units, with at least two of the plurality of opening regions having different widths.

7. The image sensor of claim 6, wherein the plurality of light guides include a light guide material,
the dielectric layer structure includes a dielectric material, and
a refraction ratio of the light guide material is greater than a refraction ratio of the dielectric material.

8. The image sensor of claim 1, wherein the plurality of light guides include an oxide-based material.

9. The image sensor of claim 1, further comprising a plurality of color filters on upper surfaces of the plurality of light guides, the plurality of color filters configured to filter the light incident from the external source and to pass the filtered light to the plurality of light guides.

10. The image sensor of claim 9, further comprising a plurality of micro lenses on the plurality of color filters, the plurality of micro lenses corresponding to the plurality of color filters.

11. A method of manufacturing an image sensor, the method comprising:
forming a plurality of photoelectric conversion units in a substrate; and
forming a plurality of light guides on upper surfaces of the plurality of photoelectric conversion units, such that each of the plurality of light guides faces and corresponds to a different one of the plurality of photoelectric conversion units, and at least two of the plurality of light guides have different widths.

12. The method of claim 11, further comprising:
forming a dielectric layer structure having at least one layer on the upper surfaces of the plurality of photoelectric conversion units; and
forming a plurality of opening regions in the dielectric layer structure, such that at least two of the plurality of opening regions are formed to have different widths, and each of the plurality of opening regions corresponds to a different one of the plurality of photoelectric conversion units,
wherein the forming of the plurality of light guides includes filling the plurality of opening regions with a light guide material, and
the forming of the plurality of photoelectric conversion units includes forming the plurality of photoelectric conversion units within active regions defined in a semiconductor substrate.

13. The method of claim 12, wherein the different widths of the plurality of opening regions are based on a refraction ratio of the light guide material.

14. The method of claim 13, wherein the dielectric layer structure includes a dielectric material, and
the refraction ratio of the light guide material is greater than a refraction ratio of the dielectric material.

15. The method of claim 12, wherein the different widths of the plurality of opening regions are based on one or more properties of light incident from an external source.

16. The method of claim 15, wherein the one or more properties of the incident light include at least one of a range of wavelengths of the light incident from the external source and a range of wavelengths of the light incident onto the photoelectric conversion units.

17. The method of claim 12, wherein the forming of the plurality of opening regions includes etching from an upper surface of the dielectric layer structure to regions above the plurality of photoelectric conversion units.

18. The method of claim 11, further comprising forming a plurality of color filters on upper surfaces of the plurality of light guides such that light incident from an external source is filtered.

19. The method of claim 18, further comprising forming a plurality of micro lenses on the plurality of color filters, such that the plurality of micro lenses correspond to the plurality of color filters.

20. An image sensing system comprising:
an image sensor configured to sense light and generate an image signal from the sensed light, the image sensor including a plurality of photoelectric conversion units and a plurality of light guides, the plurality of light guides configured to guide light incident from an external source to the plurality of photoelectric conversion units, at least two of the light guides having different widths;
a central processing unit (CPU) configured to control operations of the image sensor; and
a memory configured to store the image signal received from the image sensor controlled by the CPU.
